(19) United States
(12) Patent Application Publication
(10) Pub. No.: US 2002/0157437 A1
(43) Pub. Date: Oct. 31, 2002

(54) Coin bank with time-release lock

(76) Inventor: Ernest Laurie, Bronx, NY (US)

Correspondence Address: Richard W. Goldstein, 2071 Clove Road, Staten Island, NY, 10304, US

(21) Appl. No.: 09/844,599

(22) Filed: Apr. 27, 2001

(51) Int. Cl. E05B 43/00

(52) U.S. Cl. 70/272

(57) ABSTRACT

A coin bank with time-release lock including a housing having an openable upper end. The openable upper end, when opened, exposes a hollow interior of the housing. The hollow interior of the housing is dimensioned for holding a quantity of money therein. The openable upper end has an opening therein allowing money to be inserted into the hollow interior therethrough. A locking system is disposed within the housing. The locking system is in communication with the openable upper end. The locking system includes a first display, a second display, and a control panel. The first display and the second display are programmable by the control panel. The first display shows a current date. The second display shows a future date. The locking system opens the openable upper end once the future date and the current date correlate.

### BACKGROUND OF THE INVENTION

The present invention relates to a coin bank with time-release lock and more particularly pertains to holding a quantity of money for a predetermined length of time before automatically opening.

The use of locking enclosures is known in the prior art. More specifically, locking enclosures heretofore devised and utilized for the purpose of protecting valuables are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,815,998 to McGuire discloses a pyramid shaped coin savings bank capable of remaining closed until completely full. U.S. Pat. No. 4,982,585 to Davis discloses a timer capable of opening a bank vault at a predetermined time. U.S. Pat. No. 3,798,937 to Sysk discloses a case for holding such items as a pack of cigarettes and capable of being locked for a predetermined period of time.

While these devices fulfill their respective, particular objective and requirements, the aforementioned patents do not describe a coin bank with time-release lock for holding a quantity of money for a predetermined length of time before automatically opening.

In this respect, the coin bank with time-release lock according to the present invention substantially departs from the conventional concepts and designs of the prior art, and in doing so provides an apparatus primarily developed for the purpose of holding a quantity of money for a predetermined length of time before automatically opening.

Therefore, it can be appreciated that there exists a continuing need for a new and improved coin bank with time-release lock which can be used for holding a quantity of money for a predetermined length of time before automatically opening. In this regard, the present invention substantially fulfills this need.

### SUMMARY OF THE INVENTION

In the view of the foregoing disadvantages inherent in the known types of locking enclosures now present in the prior art, the present invention provides an improved coin bank with time-release lock. As such, the general purpose of the present invention, which will be described subsequently in greater detail, is to provide a new and improved coin bank with time-release lock which has all the advantages of the prior art and none of the disadvantages.

To attain this, the present invention essentially comprises a pyramidal housing having an openable upper end. The openable upper end, when opened, exposes a hollow interior of the housing. The hollow interior of the housing is dimensioned for holding a quantity of money therein. The openable upper end has an opening therein allowing money to be inserted into the hollow interior therethrough. A locking system is disposed within the pyramidal housing. The locking system is in communication with the openable upper end. The locking system includes a first display, a second display, and a control panel. The first display and the second display are programmable by the control panel. The first display shows a current date. The second display shows a future date. The locking system opens the openable upper end once the future date and the current date correlate.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved coin bank with time-release lock which has all the advantages of the prior art locking enclosures and none of the disadvantages.

It is another object of the present invention to provide a new and improved coin bank with time-release lock which may be easily and efficiently manufactured and marketed.

It is a further object of the present invention to provide a new and improved coin bank with time-release lock which is of durable and reliable construction.

An even further object of the present invention is to provide a new and improved coin bank with time-release lock which is susceptible of a low cost of manufacture with regard to both materials and labor, and which accordingly is then susceptible of low prices of sale to the consuming public, thereby making such a coin bank with time-release lock economically available to the buying public.

Even still another object of the present invention is to provide a new and improved coin bank with time-release lock for holding a quantity of money for a predetermined length of time before automatically opening.

Lastly, it is an object of the present invention to provide a new and improved coin bank with time-release lock including a housing having an openable upper end. The openable upper end, when opened, exposes a hollow interior of the housing. The hollow interior of the housing is dimensioned for holding a quantity of money therein. The openable upper end has an opening therein allowing money to be inserted into the hollow interior therethrough. A locking system is disposed within the housing. The locking system is in communication with the openable upper end. The locking system includes a first display, a second display, and a control panel. The first display and the second display are programmable by the control panel. The first display shows a current date. The second display shows a future date. The locking system opens the openable upper end once the future date and the current date correlate.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the coin bank with time-release lock constructed in accordance with the principles of the present invention.

FIG. 2 is a perspective view of the present invention illustrated with top in an open orientation.

The same reference numerals refer to the same parts through the various figures.

### DESCRIPTION OF THE PREFERRED EMBODIMENT

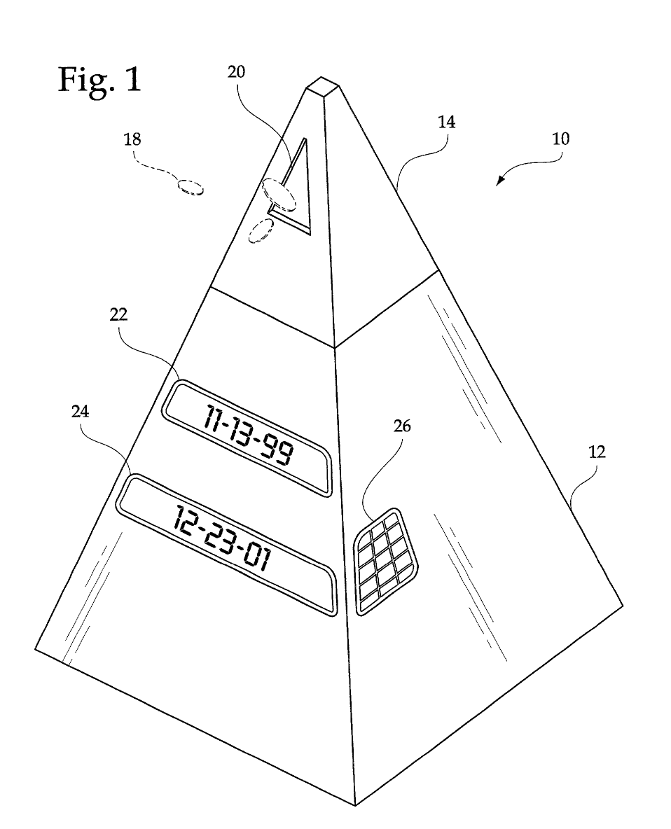

With reference now to the drawings, and in particular, to FIGS. 1 and two thereof, the preferred embodiment of the new and improved coin bank with time-release lock embodying the principles and concepts of the present invention and generally designated by the reference number 10 will be described.

Specifically, it will be noted in the various Figures that the device relates to a coin bank with time-release lock for holding a quantity of money for a predetermined length of time before automatically opening. In its broadest context, the device consists of a pyramidal housing and a locking system. Such components are individually configured and correlated with respect to each other so as to attain the desired objective.

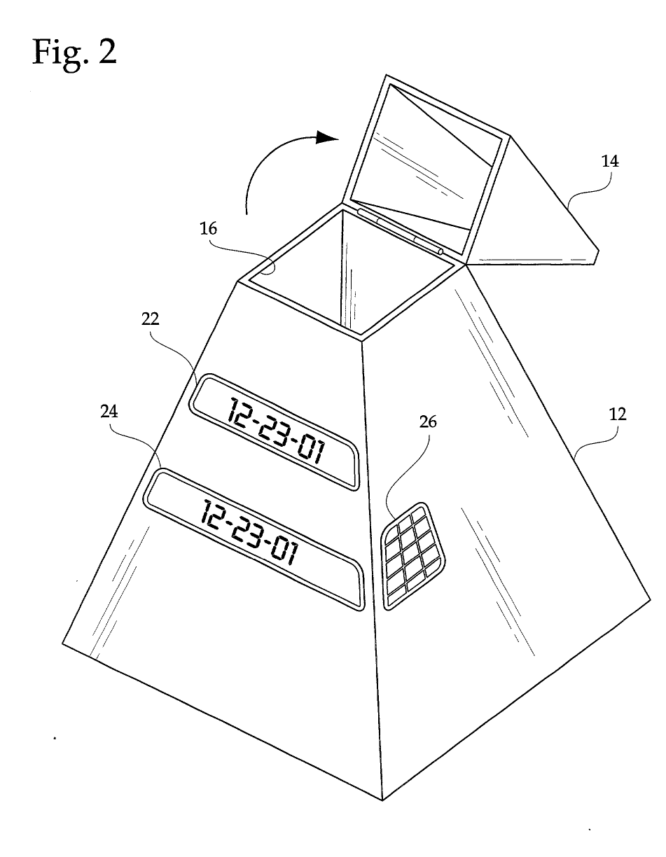

The pyramidal housing 12 has an openable upper end 14. The openable upper end 14, when opened, exposes a hollow interior 16 of the housing 12. Note FIG. 2. The hollow interior 16 of the housing 12 is dimensioned for holding a quantity of money 18 therein. The openable upper end 14 has an opening 20 therein allowing the money 18 to be inserted into the hollow interior 16 therethrough. Note FIG. 1.

The locking system is disposed within the pyramidal housing 12. The locking system is in communication with the openable upper end 14. The locking system includes a first display 22, a second display 24, and a control panel 26. The first display 22 and the second display 24 are programmable by the control panel 26. The first display 22 shows a current date. The second display 24 shows a future date. The locking system opens the openable upper end 14 once the future date and the current date correlate.

In use, the present invention acts as a forced savings bank. The user will simply set the future date on the second display 24 to correspond with a time that they will need the saved money. The openable upper end 14 will not open until this future date has arrived. The user will then deposit money into the hollow interior 16 in order to prevent them from spending the money prior to the future date. One the future date has been reached, the locking system will release the openable upper end 14 allowing the saved money to be removed.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention to the exact construction and operation shown and described, and accordingly, all suitable modification and equivalents may be resorted to, falling within the scope of the invention.

What is claimed as being new and desired to be protected by Letters Patent of the United States is as follows:

1. A coin bank with time-release lock for holding a quantity of money for a predetermined length of time before automatically opening comprising, in combination:
a pyramidal housing having an openable upper end, the openable upper end, when opened, exposing a hollow interior of the housing, the hollow interior housing being dimensioned for holding a quantity of money therein, the openable upper end having an opening therein allowing money to be inserted into the hollow interior therethrough; and
a locking system disposed within the pyramidal housing, the locking system being in communication with the openable upper end, the locking system including a first display, a second display, and a control panel, the first display and the second display being programmable by the control panel, the first display showing a current date, the second display showing a future date, the locking system opening the openable upper end once the future date and the current date correlate.

2. A coin bank with time-release lock for holding a quantity of money for a predetermined length of time before automatically opening comprising, in combination:
a housing having an openable upper end, the openable upper end, when opened, exposing a hollow interior of the housing, the hollow interior housing being dimensioned for holding a quantity of money therein, the openable upper end having an opening therein allowing money to be inserted into the hollow interior therethrough; and
a locking system disposed within the housing, the locking system being in communication with the openable upper end, the locking system including a first display, a second display, and a control panel, the first display and the second display being programmable by the control panel, the first display showing a current date, the second display showing a future date, the locking system opening the openable upper end once the future date and the current date correlate.
